(19) United States
(12) Patent Application Publication
(10) Pub. No.: US 2024/0259355 A1
(43) Pub. Date: Aug. 1, 2024

(54) INFORMATION PROCESSING APPARATUS, INFORMATION PROCESSING SYSTEM, INFORMATION PROCESSING METHOD, AND NON-TRANSITORY RECORDING MEDIUM

(71) Applicant: Kohtaroh Harada, KANAGAWA (JP)

(72) Inventor: Kohtaroh Harada, KANAGAWA (JP)

(73) Assignee: Ricoh Company, Ltd., Tokyo (JP)

(21) Appl. No.: 18/392,108

(22) Filed: Dec. 21, 2023

(30) Foreign Application Priority Data
Jan. 31, 2023 (JP) 2023-012991

(51) Int. Cl. H04L 9/40

(52) U.S. Cl. CPC H04L 63/0435

(57) ABSTRACT

An information processing apparatus for supporting migration of setting information from a first electronic apparatus to a second electronic apparatus, includes circuitry to store, in a memory, a conversion rule of setting information corresponding to the first electronic apparatus, acquire encrypted setting information and information on the first electronic apparatus from the first electronic apparatus, receive information on the second electronic apparatus, and transmit the encrypted setting information and the conversion rule corresponding to the first electronic apparatus to the second electronic apparatus.

### CROSS-REFERENCE TO RELATED APPLICATIONS

This patent application is based on and claims priority pursuant to 35 U.S.C. § 119(a) to Japanese Patent Application No. 2023-012991, filed on Jan. 31, 2023, in the Japan Patent Office, the entire disclosure of which is hereby incorporated by reference herein.

### BACKGROUND

### Technical Field

The present disclosure relates to an information processing apparatus, an information processing system, an information processing method, and a non-transitory recording medium.

### Related Art

Information processing apparatuses that support migration of setting information between electronic apparatuses, such as multifunction peripherals, of different models are known. For example, when performing migration of the setting information between the multifunction peripherals of different models, the information processing apparatus extracts setting information common to the multifunction peripherals of different models and applies only the common setting information to the multifunction peripheral as a migration destination.

### SUMMARY

In one aspect, an information processing apparatus for supporting migration of setting information from a first electronic apparatus to a second electronic apparatus, includes circuitry to store, in a memory, a conversion rule of setting information corresponding to the first electronic apparatus, acquire encrypted setting information and information on the first electronic apparatus from the first electronic apparatus, receive information on the second electronic apparatus, and transmit the encrypted setting information and the conversion rule corresponding to the first electronic apparatus to the second electronic apparatus.

In another aspect, an information processing system includes the information processing apparatus described above and a first electronic apparatus to communicate with the information processing apparatus via a communication network. The first electronic apparatus includes circuitry to receive an input of an encryption key for encrypting setting information of the first electronic apparatus and transmit the setting information of the first electronic apparatus encrypted with the encryption key and information on the first electronic apparatus to the information processing apparatus.

In another aspect, an information processing method performed by an information processing apparatus for supporting migration of setting information from a first electronic apparatus to a second electronic apparatus, includes storing, in a memory, a conversion rule of setting information corresponding to a first electronic apparatus, acquiring encrypted setting information and information on the first electronic apparatus from the first electronic apparatus, receiving information on a second electronic apparatus, and transmitting the encrypted setting information and the conversion rule corresponding to the first electronic apparatus to the second electronic apparatus.

In another aspect, a non-transitory recording medium storing a plurality of program codes which, when executed by one or more processors, causes the one or more processors to perform a method. The method includes storing, in a memory, a conversion rule of setting information corresponding to a first electronic apparatus, acquiring encrypted setting information and information on the first electronic apparatus from the first electronic apparatus, receiving information on a second electronic apparatus, and transmitting the encrypted setting information and the conversion rule corresponding to the first electronic apparatus to the second electronic apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information processing system according to an embodiment of the present disclosure;

FIG. 2 is a block diagram illustrating a hardware configuration of a computer according to an embodiment of the present disclosure;

FIG. 3 is a block diagram illustrating a hardware configuration of an image forming apparatus according to an embodiment of the present disclosure;

FIG. 4 is a block diagram illustrating a functional configuration of an information processing apparatus according to an embodiment of the present disclosure;

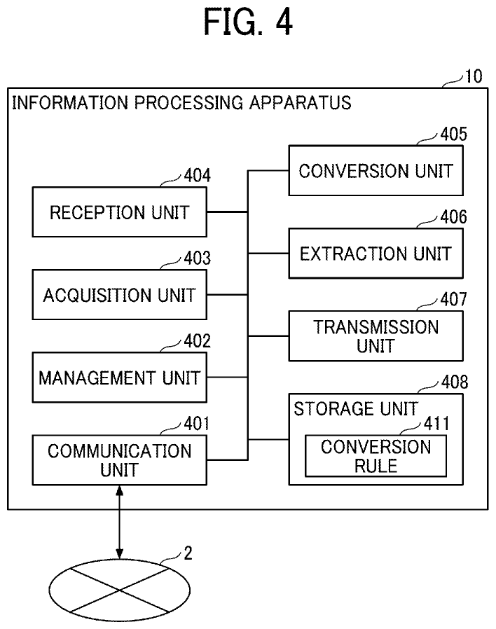

FIGS. 5A and 5B are diagrams illustrating a table of encrypted setting information and a table of decrypted setting information, respectively, according to an embodiment of the present disclosure;

FIG. 6 is a diagram illustrating a table of unencrypted setting information according to an embodiment of the present disclosure;

FIGS. 7A to 7C are diagrams each illustrating a table of conversion rules according to an embodiment of the present disclosure;

FIG. 8 is a block diagram illustrating a functional configuration of an image forming apparatus according to an embodiment of the present disclosure;

FIG. 9 is a sequence chart illustrating the processing executed by an image forming apparatus as a migration source according to the first embodiment of the present disclosure;

FIG. 10 is a sequence chart illustrating the processing executed by an information processing apparatus according to the first embodiment of the present disclosure;

FIG. 11 is a sequence chart illustrating the processing executed by an image forming apparatus as a migration destination according to the first embodiment of the present disclosure;

FIG. 12 is a sequence chart illustrating the processing executed by an information processing apparatus according to the second embodiment of the present disclosure; and

FIG. 13 is a diagram illustrating a table of conversion rules according to the second embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings.

### Configuration of Information Processing System

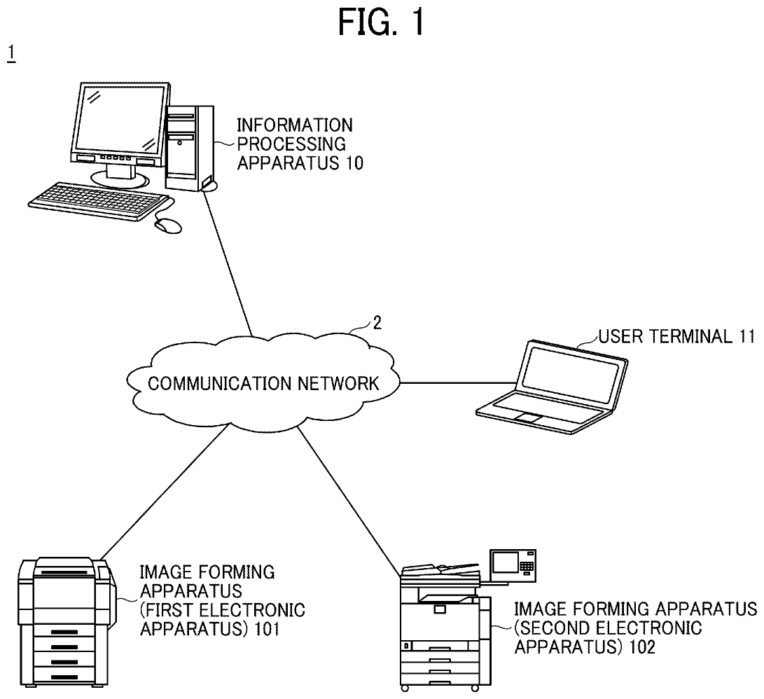

FIG. 1 is a diagram illustrating a configuration of an information processing system 1 according to an embodiment of the present disclosure. The information processing system 1 includes, for example, an information processing apparatus 10, an image forming apparatus 101, an image forming apparatus 102, and a user terminal 11, which are connected to a communication network 2 such as the Internet and a local area network (LAN). The information processing system 1, for example, is a system that supports migration process in which setting information of the image forming apparatus 101 that an operator has been using is migrated to the image forming apparatus 102 that the operator has newly introduced. In the present embodiment, it is assumed that the image forming apparatus 101 and the image forming apparatus 102 are different in, for example, model, generation, or optional configuration, or have different setting values.

The image forming apparatus 101 serves as a first electronic apparatus that is a migration source of the setting information. The image forming apparatus 102 serves as a second electronic apparatus that is a migration destination to which the setting information is to be migrated. Each of the first electronic apparatus and the second electronic apparatus is, for example, an output device such as a projector (PJ), an interactive white board (IWB; an electronic white board having a blackboard function capable of mutual communication), or a digital signage. Alternatively, each of the first electronic apparatus and the second electronic apparatus is, for example, a head-up display (HUD) device, an industrial machine, an imaging device, a sound collecting device, a medical device, a network home appliance, or an automobile (connected car).

In the following description, it is assumed that each of the first electronic apparatus and the second electronic apparatus is an image forming apparatus such as a multifunction peripheral (MFP) having, for example, a scanning function, a copying function, a printing function, and a facsimile communication function in one housing.

The information processing apparatus 10 is, for example, an information processing apparatus implemented by a computer or a system including a plurality of computers. The information processing apparatus 10 executes programs in one or more computers to support the migration process in which the setting values of the image forming apparatus 101 are migrated to the image forming apparatus 102.

Each of the image forming apparatuses 101 and 102 is, for example, an electronic apparatus such as an MFP, and is communicably connected to the information processing apparatus 10 via the communication network 2.

The user terminal 11 is, for example, an information terminal such as a personal computer (PC), a tablet terminal, or a smartphone. The user terminal 11 is used by the operator to log in to the information processing apparatus 10 and input, for example, information on the image forming apparatus 102 as the migration destination to the information processing apparatus 10.

### Overview of Migration Process

When the operator performs an operation of migration of the setting information of in the image forming apparatus 101, the image forming apparatus 101 transmits the setting information of the image forming apparatus 101 to the information processing apparatus 10. In the present embodiment, it is assumed that the setting information of the image forming apparatus 101 includes unencrypted setting information and encrypted setting information. For example, the image forming apparatus 101 encrypts confidential information such as user information or a password to obtain encrypted setting information, and transmits the encrypted setting information to the information processing apparatus 10.

The information processing apparatus 10 manages a conversion rule of the setting information corresponding to the image forming apparatus 101. For example, in a case where the setting information is unencrypted, when the information processing apparatus 10 receives information on the image forming apparatus 102 as the migration destination from the user terminal 11, the information processing apparatus 10 converts the unencrypted setting information into setting information suitable to the image forming apparatus 102 as the migration destination according to the conversion rule. On the other hand, in a case where the setting information is encrypted, since the information processing apparatus 10 does not have an encryption key for decrypting the encrypted setting information, the information processing apparatus 10 cannot decrypt the encrypted setting information or convert the encrypted setting information into setting information suitable to the image forming apparatus 102. Note that inputting the encryption key into the information processing apparatus 10 to decrypt the setting information encrypted by the information processing apparatus 10 is undesirable from a security perspective because there is a risk of information leakage.

Accordingly, when the setting information acquired from the image forming apparatus 101 as the migration source includes the encrypted setting information that needs to be changed, there is an inconvenience that the information processing apparatus 10 cannot migrate the encrypted setting information to the image forming apparatus 102 as the migration destination.

In view of the above, the information processing apparatus 10 according to the present embodiment has a function of transmitting the unencrypted setting information converted for the image forming apparatus 102 as the migration destination, the encrypted setting information, and the conversion rule of the setting information to the image forming apparatus 102 as the migration destination.

The image forming apparatus 102 stores, for example, the encrypted setting information and the conversion rule of the setting information received from the information processing apparatus 10 in, for example, a storage device. When receiving an input of an encryption key performed by the operator, the image forming apparatus 102 decrypts the encrypted setting information using the encryption key input by the operator. The image forming apparatus 102 converts the decrypted setting information into setting information suitable to the image forming apparatus 102 using the conversion rule of the setting information, and sets (for example, stores) the converted setting information in the image forming apparatus 102.

As a result, according to the information processing system 1 of the present embodiment, even when the setting information acquired from the image forming apparatus (electronic apparatus) 101 as the migration source is encrypted, the encrypted setting information can be migrated to the image forming apparatus (electronic apparatus) 102 as the migration destination.

One example case in which the setting information is converted using the information processing apparatus 10 is as follows. When a new model of the image forming apparatus is released, it is sufficient to add a conversion process only to the information processing apparatus 10 to maintain compatibility. If the conversion process were to be performed to each of the image forming apparatuses 101 and 102, the conversion process should be updated for each of the image forming apparatuses 101 and 102 at each time a new model is released.

The configuration of the information processing system 1 illustrated in FIG. 1 is given by way of example. For example, the configuration may be such that the operator directly operates the information processing apparatus 10 without using the user terminal 11.

### Hardware Configurations

The hardware configuration of each apparatus included in the information processing system 1 is described below.

### Hardware Configuration of Information Processing Apparatus and User Terminal

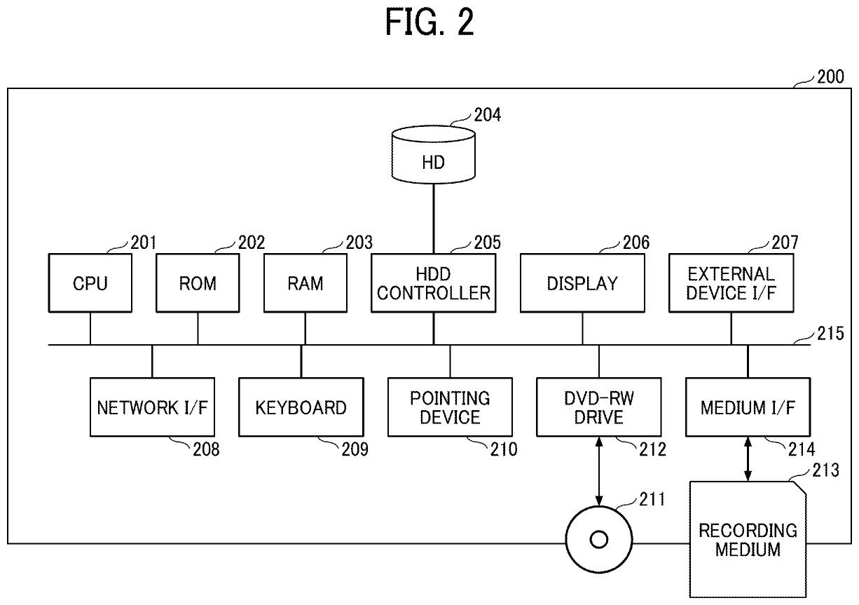

The information processing apparatus 10 has, for example, a hardware configuration of a computer 200 as illustrated in FIG. 2. Alternatively, the information processing apparatus 10 is configured by a plurality of computers 200. The user terminal 11 has, for example, a hardware configuration of the computer 200 as illustrated in FIG. 2.

FIG. 2 is a block diagram illustrating a hardware configuration of the computer 200 according to an embodiment of the present disclosure. As illustrated in FIG. 2, the computer 200 includes, for example, a central processing unit (CPU) 201, a read-only memory (ROM) 202, a random access memory (RAM) 203, a hard disk (HD) 204, a hard disk drive (HDD) controller 205, a display 206, an external device interface (I/F) 207, a network I/F 208, a keyboard 209, a pointing device 210, a digital versatile disc-rewritable (DVD-RW) drive 212, a medium I/F 214, and a bus line 215.

The CPU 201 controls the entire operation of the computer 200 by executing programs. The ROM 202 stores, for example, a program used to boot the computer 200 such as a start-up file and data. The RAM 203 is used as, for example, a work area for the CPU 201. The HD 204 stores, for example, programs such as an operating system (OS), an application, and a device driver, and various data. The HDD controller 205 controls, for example, the reading and writing of various data from and to the HD 204 under the control of the CPU 201.

The display 206 displays various information such as a cursor, a menu, a window, characters, and images. The display 206 may be disposed outside the computer 200. The external device I/F 207 is an interface for connecting various external devices such as an external memory to the computer 200. The network I/F 208 is an interface for data communication using, for example, the communication network 2.

The keyboard 209 serves as an input device provided with a plurality of keys used for, for example, inputting characters, numerical values, and various instructions. The pointing device 210 serves as an input device used for, for example, selecting or executing various instructions, selecting an object to be processed, and moving a cursor being displayed. The keyboard 209 and the pointing device 210 may be disposed outside the computer 200.

The DVD-RW drive 212 controls the reading and writing of various data from and to a DVD-RW 211, which serves as a removable storage medium according to the present embodiment. The DVD-RW 211 may be another type of removable recording medium. The medium I/F 214 controls the reading and writing (storing) of data from and to a recording medium 213 such as a flash memory. The bus line 215 includes an address bus and a data bus. The bus line 215 electrically connects the above-described components to each other and transmits various control signals.

The configuration of the computer 200 illustrated in FIG. 2 is given by way of example. As long as the computer 200 includes, for example, the CPU 201, the ROM 202, the RAM 203, and the network I/F 208, any other components may be included in the configuration of the computer 200.

### Hardware Configuration of Image Forming Apparatus

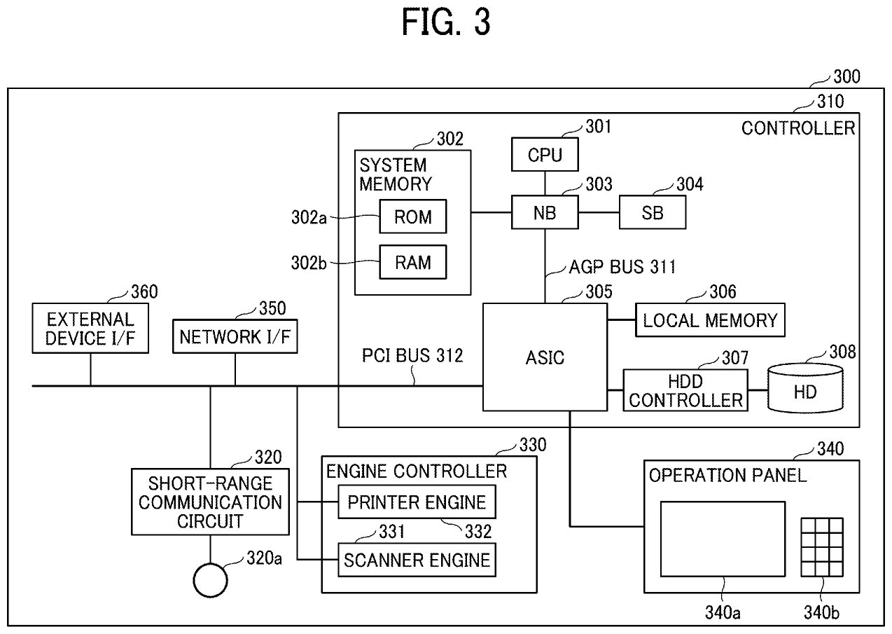

Each of the image forming apparatuses 101 and 102 has, for example, a hardware configuration of an image forming apparatus 300 as illustrated in FIG. 3.

FIG. 3 is a block diagram illustrating a hardware configuration of the image forming apparatus 300 according to an embodiment of the present disclosure. As illustrated in FIG. 3, the image forming apparatus 300 includes, for example, a controller 310, a short-range communication circuit 320, an engine controller 330, an operation panel 340, a network I/F 350, and an external device I/F 360.

The controller 310 includes a CPU 301 as a processor of a computer, a system memory 302, a north bridge (NB) 303, a south bridge (SB) 304, an application specific integrated circuit (ASIC) 305, a local memory 306 as a storage area, an HDD controller 307, and an HD 308 as a storage area. The NB 303 and the ASIC 305 are connected through an accelerated graphics port (AGP) bus 311.

The CPU 301 controls the entire operation of the image forming apparatus 300 by executing programs. The NB 303 is a bridge for connecting the CPU 301 with the system memory 302, the SB 304, and the AGP bus 311. The NB 303 includes a memory controller for controlling the reading and writing of various data from and to the system memory 302, a peripheral component interconnect (PCI) master, and an AGP target.

The system memory 302 includes a ROM 302a and a RAM 302b. The ROM 302a stores programs and data for implementing various functions of the controller 310. The RAM 302b is used to load the programs and the data. The RAM 302b is used as, for example, a drawing memory to store drawing data for printing. The programs stored in the ROM 302a may be stored in any computer-readable recording medium, such as a compact disc read-only memory (CD-ROM), a compact disc-recordable (CD-R), or a digital versatile disc (DVD), in an installable or executable file format and provided as a computer program product. The ROM 302a serves as a storage area for start-up, and stores the start-up file 121.

The SB 304 is a bridge that connects the NB 303 to PCI devices and peripheral devices. The ASIC 305 is an integrated circuit (IC) dedicated to image processing and includes hardware elements for image processing. The ASIC 305 serves as a bridge to connect the AGP bus 311, a PCI bus 312, the HDD controller 307, and the local memory 306 to each other. The ASIC 305 includes a PCI target, an AGP master, an arbiter (ARB) as a central processor of the ASIC 305, a memory controller to control the local memory 306, a plurality of direct memory access controllers (DMACs), and a PCI unit. For example, the DMACs convert coordinates of image data with hardware logic to rotate an image based on the image data. The PCI unit transfers data between a scanner engine 331 and a printer engine 332 through the PCI bus 312. The ASIC 305 may be connected to a universal serial bus (USB) interface, or the Institute of Electrical and Electronics Engineers 1394 (IEEE1394) interface.

The local memory 306 is a memory used as a buffer for image data to be copied or a code buffer. The HD 308 is a storage device that stores image data, font data for printing, and form data. The HD 308 stores, for example, programs such as an OS, an application, and a device driver, and various data. The HDD controller 307 controls the reading and writing of data from and to the HD 308 under the control of the CPU 301. The AGP bus 311 is a bus interface for a graphics accelerator card, which has been proposed to accelerate graphics processing. The AGP bus 311 directly accesses the system memory 302 with high throughput to accelerate the graphics accelerator card.

The short-range communication circuit 320 performs various kinds of short-range wireless communication using, for example, an antenna 320a for the short-range communication circuit. The engine controller 330 includes, for example, the scanner engine 331 and the printer engine 332. The scanner engine 331 is a reading device that scans a document, for example. The printer engine 332 is a printing device that prints an image representing print data on a printing medium. The scanner engine 331 or the printer engine 332 includes an image processor to perform, for example, error diffusion and gamma conversion.

The operation panel 340 includes a display panel 340a and a hard keypad 340b. The display panel 340a is, for example, a touch panel that displays current settings or a selection screen and receives user input. The hard keypad 340b includes, for example, a numeric keypad and a start key. The numeric keypad receives assigned values of image forming parameters such as an image density parameter. The start key receives an instruction to start copying, for example. The controller 310 controls the entire operation of the image forming apparatus 300. For example, the controller 310 controls, for example, drawing, communication, and input through the operation panel 340.

The image forming apparatus 300 may sequentially switch to select a document server function, a copying function, a printing function, and a facsimile communication function by an application switching key of the operation panel 340. When the document server function is selected, an operation mode switches to a document box mode. With the selection of the copying function, the operation mode switches to a copy mode. With the selection of the printing function, the operation mode switches to a printer mode. With the selection of the facsimile communication function, the operation mode switches to a facsimile mode.

The network I/F 350 is an interface for data communication using the communication network 2. The external device I/F 360 is an interface for connecting various external devices to the image forming apparatus 300. The short-range communication circuit 320, the network I/F 350, and the external device I/F 360 are electrically connected to the ASIC 305 via, for example, the PCI bus 312.

The hardware configuration of the image forming apparatus 300 illustrated in FIG. 3 is given by way of example as a hardware configuration of an electronic apparatus. As long as the electronic apparatus includes, for example, the CPU 301, the ROM 302a, the RAM 302b, and the network I/F 208, any other components may be included in the configuration of the electronic apparatus.

### Functional Configurations

The functional configurations of the information processing apparatus 10 and the image forming apparatuses 101 and 102 are described below.

### Functional Configuration of Information Processing Apparatus

The information processing apparatus 10 implements, for example, a communication unit 401, a management unit 402, an acquisition unit 403, a reception unit 404, a conversion unit 405, an extraction unit 406, and a transmission unit 407 by the CPU 201 executing programs stored in a recording medium. In some embodiments, at least a part of the functional units described above may be implemented by hardware.

The information processing apparatus 10 also includes a storage unit 408 implemented by, for example, storage devices such as the HD 204 and the HDD controller 205.

The communication unit 401 connects the information processing apparatus 10 to the communication network 2, for example, using the network I/F 208, and executes communication processing for communicating with other apparatuses such as the image forming apparatuses 101 and 102.

The management unit 402 executes management processing for managing conversion rules 411 corresponding to the image forming apparatus 101 as the migration source (first electronic apparatus). For example, the management unit 402 stores the conversion rules 411 in the storage unit 408 and manages the conversion rules 411. The management unit 402 may store the conversion rules 411 in an external storage device (for example, a storage server or a cloud service) and manage the conversion rules 411.

The acquisition unit 403 executes acquisition processing for acquiring the setting information transmitted from the image forming apparatus 101 as the migration source (first electronic apparatus). The setting information transmitted by the image forming apparatus 101 as the migration source includes, for example, unencrypted setting information, encrypted setting information, information on the image forming apparatus 101 as the migration source (information on the first electronic apparatus), and a user identification (ID). The information on the image forming apparatus 101 as the migration source includes, for example, information for specifying the model of the image forming apparatus 101.

The reception unit 404 displays, for example, a user interface (UI) screen such as a login screen or a setting screen on the user terminal 11 or the display 206, and executes reception processing for receiving information input by the operator. For example, the reception unit 404 receives information on the image forming apparatus 102 as the migration destination (information on the second electronic apparatus). The information on the image forming apparatus 102 as the migration destination includes, for example, information for identifying the image forming apparatus 102 and specifying the model of the image forming apparatus 102.

The conversion unit 405 executes conversion processing for converting the unencrypted setting information into setting information suitable to the image forming apparatus 102 as the migration destination based on a conversion rule 411 for the setting information corresponding to the image forming apparatus 101 as the migration source.

When the conversion rules 411 include conversion rules corresponding to a plurality of image forming apparatuses, the extraction unit 406 executes extraction processing for extracting conversion rules corresponding to the image forming apparatus 101 as the migration source from the conversion rules 411.

The transmission unit 407 executes transmission processing for transmitting the encrypted setting information and the setting information including the conversion rules corresponding to the image forming apparatus 101 as the migration source (first electronic apparatus) to the image forming apparatus 102 as the migration destination (second electronic apparatus).

The storage unit 408 stores, for example, various information such as the conversion rules 411 described above and the setting information received from the image forming apparatus 101 as the migration source, data, and programs.

### Information Managed by Information Processing Apparatus

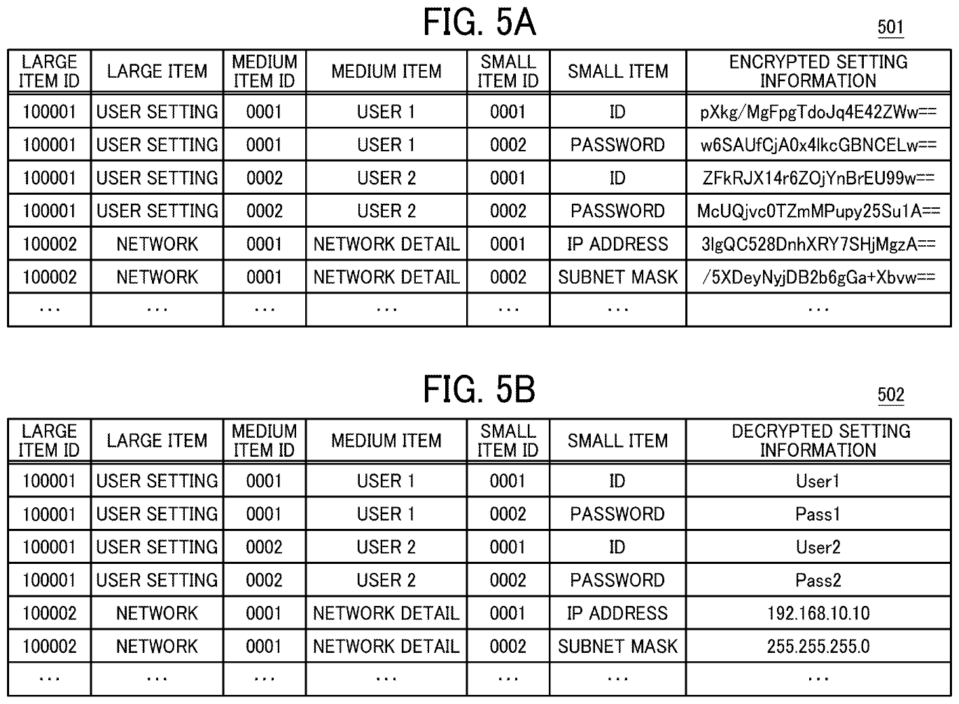

FIGS. 5A and 5B are diagrams illustrating a table of encrypted setting information 501 and a table of decrypted setting information 502, respectively, according to an embodiment of the present disclosure. In FIG. 5A, the encrypted setting information 501 included in the setting information acquired by the information processing apparatus 10 from, for example, the image forming apparatus 101 as the migration source is presented. The encrypted setting information 501 is given by way of example.

The image forming apparatus 101 as the migration source encrypts confidential information such as user information, authentication information, or network information among the pieces of the setting information of the image forming apparatus 101 and transmits the encrypted setting information 501 as illustrated in FIG. 5A to the information processing apparatus 10.

The setting information of the image forming apparatus 101 may be classified into, for example, a large item (large category), a medium item (medium category), and a small item (small category), and may have a hierarchical structure (or may not have a hierarchical structure), as illustrated in, for example, FIG. 5A. In FIG. 5A, for example, setting values of the user ID, a user password, an internet protocol (IP) address of the image forming apparatus 101, and a subnet mask are encrypted and included in the encrypted setting information.

The encryption algorithm used for encrypting the setting information may be any encryption algorithm. In FIG. 5A, by way of example, an encryption algorithm of Advanced Encryption Standard (AES) 256 is used, and encryption is performed by designating “test” as an encryption key.

In this case, by decrypting the encrypted setting information 501 with AES 256 using the encryption key “test” used for the encryption, for example, the decrypted setting information 502 as illustrated in FIG. 5B is obtained.

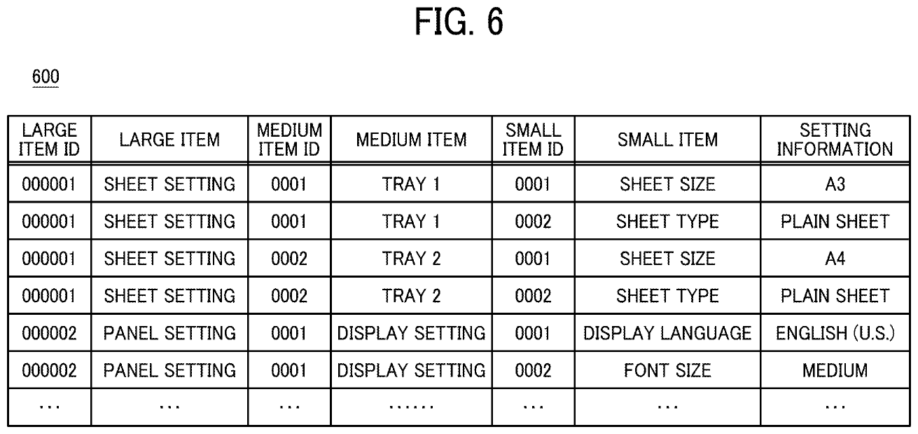

FIG. 6 is a diagram illustrating a table of unencrypted setting information 600 according to an embodiment of the present disclosure. In FIG. 6, the unencrypted setting information 600 included in the setting information acquired by the information processing apparatus 10 from, for example, the image forming apparatus 101 as the migration source is presented. The unencrypted setting information 600 is given by way of example.

The image forming apparatus 101 as the migration source transmits, to the information processing apparatus 10, information with low confidentiality among the pieces of the setting information of the image forming apparatus 101 as the unencrypted setting information 600. The information with low confidentiality is, for example, a sheet size, a sheet type, a display language, or a font size. The image forming apparatus 101 as the migration source may transmit the information with low confidentiality to the information processing apparatus 10 also in the form of the encrypted setting information 501.

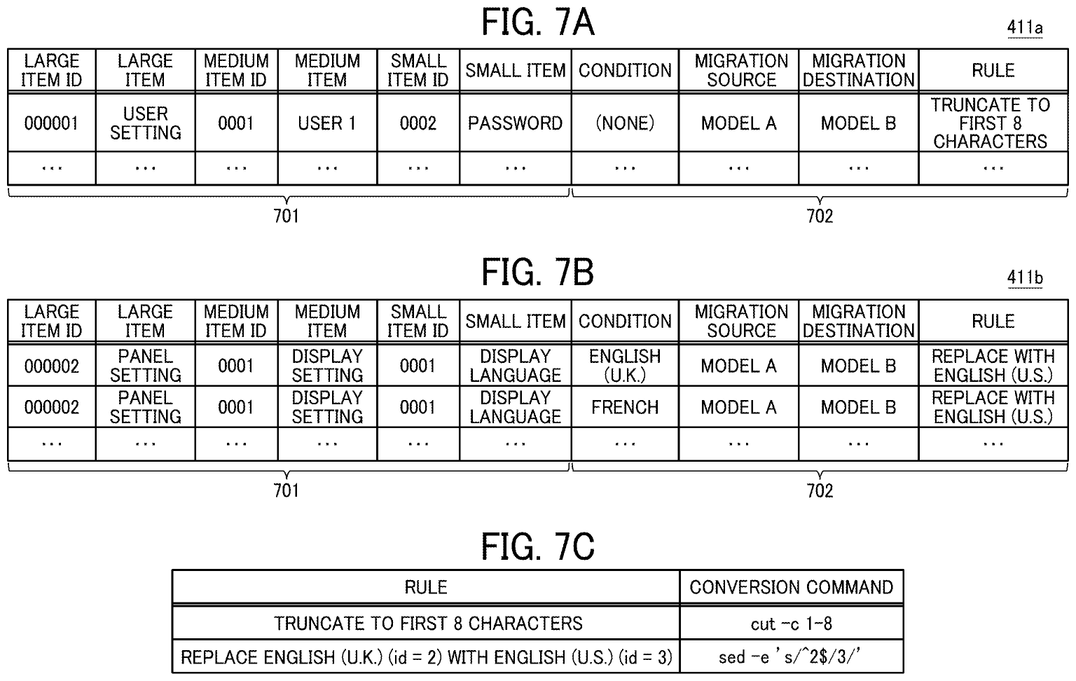

FIGS. 7A to 7C are diagrams each illustrating a table of conversion rules according to an embodiment of the present disclosure. In FIG. 7A, a table of conversion rules 411a for the encrypted setting information is presented. The conversion rules 411a are given by way of example. In the conversion rules 411a for the encrypted setting information, the large item ID, the large item, the middle item ID, the middle item, the small item ID, and the small item belong to an information part 701 that specifies the setting information, and the condition, the migration source, the migration destination, and the rule belong to a conversion rule part 702.

In the conversion rule part 702, the “condition” indicates that the “rule” is to be applied, for example, when the setting information specified by the information part 701 for specifying the setting information satisfies the “condition.” When the “condition” is “none,” the “rule” is applied unconditionally. The “migration source” is information that indicates, for example, the model of the image forming apparatus 101 as the migration source. The “migration destination” is information that indicates, for example, the model of the image forming apparatus 102 as the migration destination.

For example, it is assumed that the model of the image forming apparatus 101 as the migration source is “model A” and the model of the image forming apparatus 102 as the migration destination is “model B.” Further, it is assumed that the password for the model A is “eight or more single-byte characters and equal to or less than 256 single-byte characters,” and the password for the model B is “four or more single-byte characters and equal to or less than eight single-byte characters.”

Furthermore, it is assumed that a password of nine or more single-byte characters is set in the image forming apparatus 101. In this case, the password of the image forming apparatus 101 cannot be migrated to the image forming apparatus 102 because the number of characters exceeds when the migration of the password is performed.

For this reason, the information processing system 1 simply truncates the password of the image forming apparatus 101 having nine or more characters (e.g., “1234567890”) to eight characters based on, for example, one of the conversion rules 411a, and converts the password into a password of eight characters (e.g., “12345678”). Accordingly, the information processing system 1 can cause the password of the nine or more single-byte characters of the image forming apparatus 101 as the migration source to be migrated to the image forming apparatus 102 as the migration destination.

In FIG. 7B, a table of conversion rules 411b for the unencrypted setting information is presented. The conversion rules 411b are given by way of example. For example, it is assumed that the model of the image forming apparatus 101 as the migration source is “model A,” and the model of the image forming apparatus 102 as the migration destination is “model B.” Further, it is assumed that the model A supports “Japanese,” “English (U.K.),” “English (U.S.),” and “French” as display languages, and the model B supports “Japanese” and “English (U.S.)” as display languages.

Furthermore, it is assumed that “English (U.K.)” (or “French”) is set to the display language of the image forming apparatus 101. In this case, when the display language of the image forming apparatus 101 is migrated to the image forming apparatus 102, the migration of the setting of the display language cannot be performed because the image forming apparatus 102 has no corresponding display language.

For example, based on one of the conversion rules 411b, when the display language of the image forming apparatus 101 satisfies the condition “English (U.K.),” the conversion unit 405 of the information processing apparatus 10 replaces the display language “English (U.K.)” with “English (U.S.)” according to the rule “Replace with English (U.S.).” Accordingly, the conversion unit 405 can migrate the display language “English (U.K.)” of the image forming apparatus 101 as the migration source to the image forming apparatus 102 as the migration destination as the display language “English (U.S.).”

In FIGS. 7A and 7B according to the present embodiment, the “rules” of the conversion rules 411a and 411b are written in Japanese. However, the description of the rules may be written, for example, in the form of a “conversion command” for executing the rules as illustrated in FIG. 7C. In FIG. 7C according to the present embodiment, the conversion command “cut -c 1-8” operates as a shell command of UNIX and is a command for executing the rule “truncate to the first eight characters.” Similarly, the conversion command “sed -e ‘s/\hat{ }2$/3/’” operates as a shell command of UNIX and is a command for executing the rule “Replace English (U.K.) (id=2) with English (U.S.) (id=3).”

Further, the “rules” in the conversion rules 411a and 411b may be, for example, rules in which the processing contents are defined by, for example, a function or a script. The conversion rules 411a and 411b presented in FIGS. 7A and 7B are given by way of example, and various modifications or applications are applicable to the conversion rules.

### Functional Configuration of Image Forming Apparatuses

Each of the image forming apparatuses 101 and 102 implements, for example, a communication unit 801, a UI unit 802, an information transmission unit 803, an encryption unit 804, an information reception unit 805, a decryption unit 806, a conversion unit 807, and a setting unit 808 by the CPU 301 executing programs stored in a recording medium. In some embodiments, at least a part of the functional units described above may be implemented by hardware.

Each of the image forming apparatuses 101 and 102 also includes a storage unit 809 implemented by storage devices such as the HD 308 and the HDD controller 307.

The communication unit 801 connects the image forming apparatuses 101 and 102 to which the communication unit 801 belongs to the communication network 2, for example, using the network I/F 350, and executes communication processing for communicating with other apparatuses such as the information processing apparatus 10.

The UI unit 802 displays, for example, a UI screen such as a login screen, a setting screen, or an operation screen on, for example, the operation panel 340, and executes UI processing for receiving login information, setting information, or operation information input by the operator. For example, the UI unit 802 receives an input of an encryption key for encrypting the setting information or an encryption key for decrypting the encrypted setting information.

The information transmission unit 803 executes information transmission processing for transmitting, to the information processing apparatus 10, for example, the setting information of the image forming apparatus 101 as the migration source, which is encrypted with the encryption key received by the UI unit 802, and the setting information including the information on the image forming apparatus 101.

The encryption unit 804 executes encryption processing for encrypting the setting information of the image forming apparatus 101 as the migration source with the encryption key received by the UI unit 802.

The information reception unit 805 executes information reception processing for receiving the encrypted setting information and the setting information including the conversion rule, which are transmitted from the information processing apparatus 10.

The decryption unit 806 executes decryption processing for decrypting the encrypted setting information received by the information reception unit 805 with the encryption key received by the UI unit 802.

The conversion unit 807 executes conversion processing for converting the setting information decrypted by the decryption unit 806 into the setting information suitable to the image forming apparatus 102 as the migration destination according to the conversion rule received by the information reception unit 805.

The setting unit 808 executes setting processing for setting, for example, the setting information suitable to the image forming apparatus 102 as the migration destination converted by the conversion unit 807 in the image forming apparatus 102 as the migration destination.

The storage unit 809 stores, for example, various data such as the setting information received by the information reception unit 805, information, and programs.

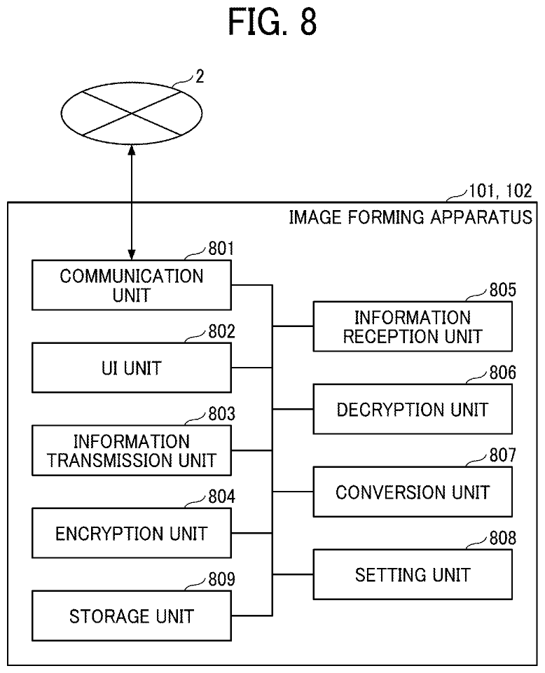

According to the functional configuration illustrated in FIG. 8, the image forming apparatuses 101 and 102 function as the image forming apparatus 101 as the migration source or the image forming apparatus 102 as the migration destination. The image forming apparatus 101 as the migration source may not include, for example, the information reception unit 805, the decryption unit 806, the conversion unit 807, and the setting unit 808 among the functional units of the functional configuration illustrated in FIG. 8. The image forming apparatus 102 as the migration destination may not include, for example, the information transmission unit 803 and the encryption unit 804 among the functional units of the functional configuration illustrated in FIG. 8.

### Processing Flow

Subsequently, a processing flow of the information processing method according to the present embodiment is described below.

### First Embodiment

### Processing Executed by Image Forming Apparatus as Migration Source

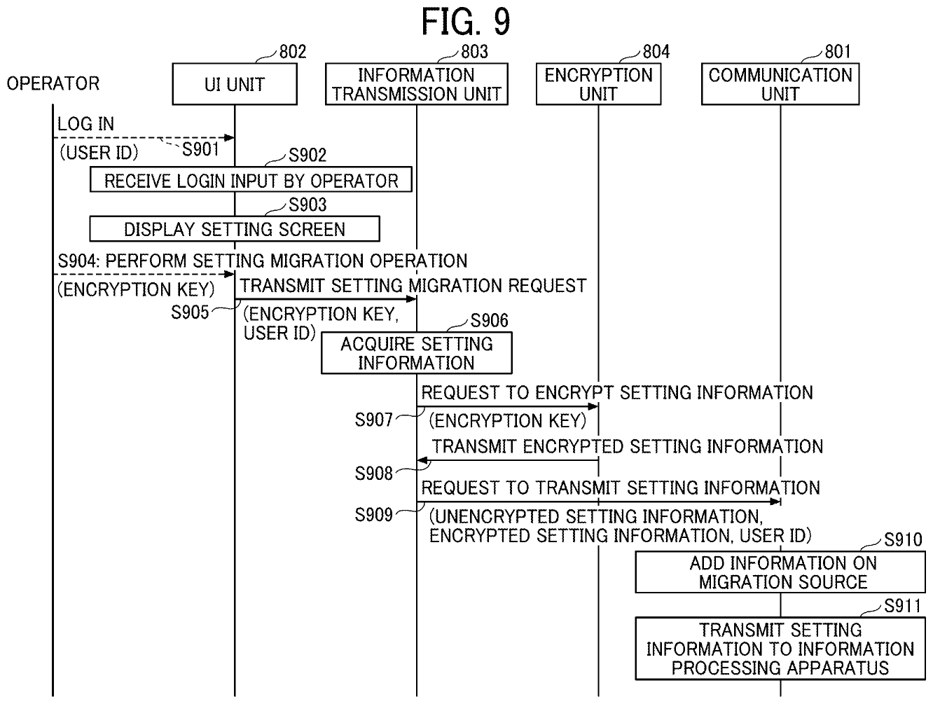

FIG. 9 is a sequence chart illustrating the processing executed by the image forming apparatus as the migration source according to the first embodiment of the present disclosure. This processing is given by way of example as the processing executed by the image forming apparatus 101 as the migration source (first electronic apparatus) having, for example, a functional configuration as illustrated in FIG. 8.

In step S901, the operator who has the authority of an administrator for the information processing system 1 performs a login operation on the image forming apparatus 101 as the migration source. This login operation may be performed by inputting a user ID and a password to the login screen displayed by the UI unit 802. Alternatively, the login operation may be performed using, for example, IC card authentication or biometric authentication.

In steps S902 and S903, in response to receiving the login performed by the operator having the authority of an administrator, the UI unit 802 of the image forming apparatus 101 displays a setting screen for receiving a setting migration operation for causing the setting information to be migrated.

In step S904, the operator performs a setting migration operation on the setting screen displayed by the UI unit 802. For example, the operator selects a setting migration button displayed on the setting screen and inputs an encryption key into the encryption key input field.

In step S905, the UI unit 802 transmits a setting migration request that includes, for example, the encryption key input by the operator and the user ID to the information transmission unit 803.

In step S906, the information transmission unit 803 of the image forming apparatus 101 acquires the setting information of the image forming apparatus 101 as the migration source.

In step S907, the information transmission unit 803 transmits an encryption request for encrypting the setting information acquired by the information transmission unit 803 to the encryption unit 804. This encryption request includes, for example, the encryption key transmitted by the UI unit 802.

Preferably, the information transmission unit 803 requests the encryption unit 804 to encrypt setting information set in advance (e.g., user information, network information) among the setting information acquired by the information transmission unit 803.

In step S908, the encryption unit 804 encrypts the setting information included in the encryption request with the encryption key and transmits the encrypted setting information to the information transmission unit 803. Accordingly, the information transmission unit 803 acquires, for example, the encrypted setting information 501 as illustrated in FIG. 5A.

In step S909, the information transmission unit 803 transmits, to the communication unit 801, a transmission request for transmitting the setting information. In the present embodiment, the setting information includes, for example, unencrypted setting information as illustrated in FIG. 6, encrypted setting information as illustrated in FIG. 5A, and information such as a user ID.

In steps S910 and S911, the communication unit 801 adds the information on the image forming apparatus 101 as the migration source to the setting information transmitted by the information transmission unit 803, and transmits the added setting information to the information processing apparatus 10. In the present embodiment, the information on the image forming apparatus 101 as the migration source includes information for specifying, for example, the model of the image forming apparatus 101 (for example, a model name, a model ID, or an apparatus ID).

Instead of the communication unit 801, the information transmission unit 803 may execute the processing of adding the information on the image forming apparatus 101 as the migration source to the setting information.

Through the processing of FIG. 9, the image forming apparatus 101 as the migration source transmits the setting information including, for example, the unencrypted setting information, the encrypted setting information, the user ID, and the information on the image forming apparatus 101 to the information processing apparatus 10.

### Processing Executed by Information Processing Apparatus

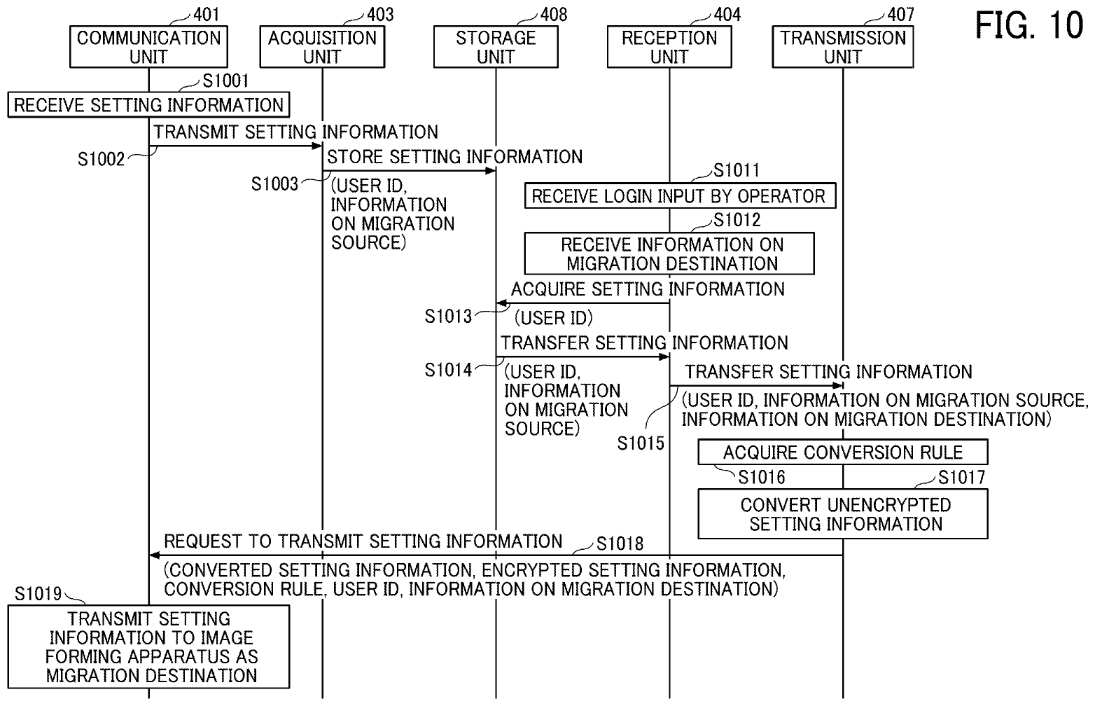

FIG. 10 is a sequence chart illustrating the processing executed by the information processing apparatus 10 according to an embodiment of the present disclosure. This processing is given by way of example as the processing executed by the information processing apparatus 10 after the image forming apparatus 101 as the migration source executes the processing illustrated in FIG. 9.

In step S1001, the communication unit 401 of the information processing apparatus 10 receives the setting information transmitted by the image forming apparatus 101 as the migration source in step S911 of the processing illustrated in FIG. 9.

In steps S1002 and S1003, the acquisition unit 403 of the information processing apparatus 10 acquires the setting information received by the communication unit 401, and stores the acquired setting information in, for example, the storage unit 408. As described above, this setting information includes, in addition to the unencrypted setting information and the encrypted setting information, for example, the user ID and the information on the image forming apparatus 101 as the migration source.

After the execution of the processing of steps S1001 to S1003, when the reception unit 404 of the information processing apparatus 10 receives the login input by the operator in step S1011, the information processing apparatus 10 executes the processing of step S1012 and subsequent steps. In the present embodiment, it is assumed that the operator whose login is received by the reception unit 404 is the same operator who has logged in the image forming apparatus 101 as the migration source in step S901 of the processing illustrated in FIG. 9.

In step S1012, the reception unit 404 acquires information on the image forming apparatus 102 as the migration destination. The information on the image forming apparatus 102 as the migration destination includes, for example, information for identifying the image forming apparatus 102 as the migration destination and specifying the model of the image forming apparatus 102.

In steps S1013 and S1014, the reception unit 404 acquires the setting information corresponding to the user ID from the storage unit 408 using the user ID of the logged-in operator. When a plurality of pieces of setting information corresponding to the user ID is stored in the storage unit 408, the reception unit 404 may display a list of pieces of the setting information corresponding to the user ID and allow the operator to select a piece of the setting information to be acquired.

In step S1015, the reception unit 404 adds the information on the image forming apparatus 102 as the migration destination received in step S1012 to the setting information acquired from the storage unit 408, and transmit the added setting information to the transmission unit 407.

In step S1016, the transmission unit 407 of the information processing apparatus 10 acquires a conversion rule 411 corresponding to the image forming apparatus 101 as the migration source. For example, the transmission unit 407 acquires, from, for example, the storage unit 408, a conversion rule 411a for the encrypted setting information as illustrated in FIG. 7A and a conversion rule 411b for the unencrypted setting information as illustrated in FIG. 7B.

In step S1017, the transmission unit 407 causes the conversion unit 405 to convert the unencrypted setting information included in the setting information transmitted by the reception unit 404 into setting information suitable to the image forming apparatus 102 as the migration destination. For example, the conversion unit 405 converts the unencrypted setting information 600 illustrated in FIG. 6 into the setting information suitable to the image forming apparatus 102 as the migration destination using the conversion rule 411b for the unencrypted setting information illustrated in FIG. 7B.

In step S1018, the transmission unit 407 transmits, to the communication unit 401, a transmission request for transmitting the setting information. In the present embodiment, for example, the unencrypted setting information converted in step S1017, the encrypted setting information, the conversion rule 411a for the encrypted setting information, the user ID, and the information on the image forming apparatus 102 as the migration destination are included in the setting information requested to be transmitted.

In step S1019, the communication unit 401 transmits the setting information requested by the transmission unit 407 to the image forming apparatus 102 as the migration destination.

Through the processing of FIG. 10, the information processing apparatus 10 transmits the setting information including, for example, the unencrypted setting information, the encrypted setting information, the conversion rule 411a for the encrypted setting information, and the user ID to the image forming apparatus 102 as the migration destination.

### Processing Executed by Image Forming Apparatus as Migration Destination

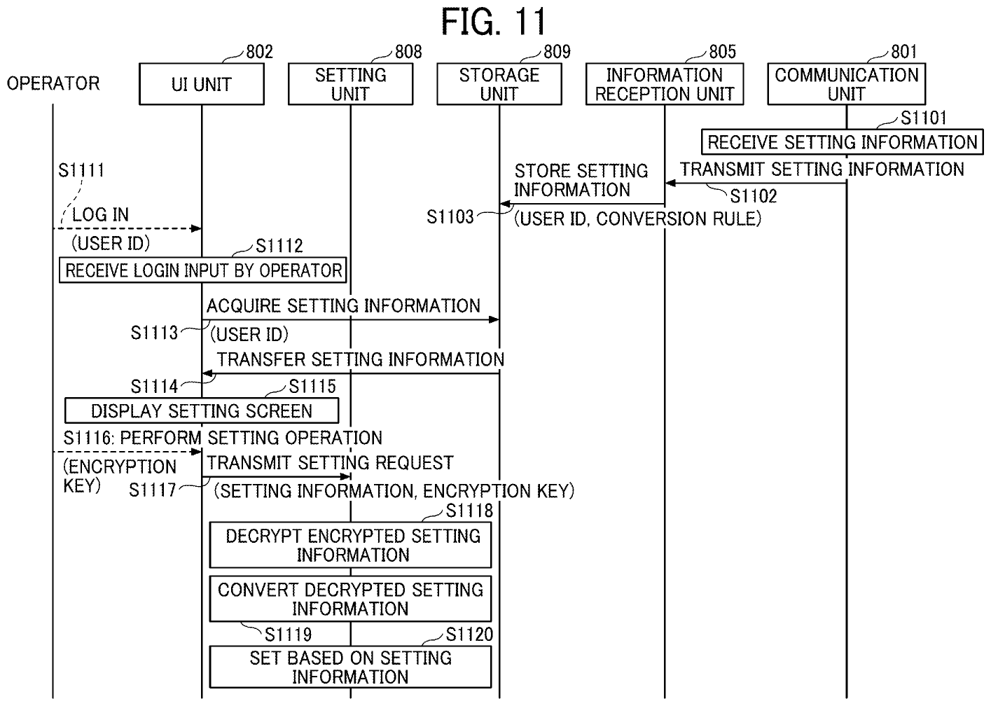

FIG. 11 is a sequence chart illustrating the processing executed by the image forming apparatus 102 as the migration destination according to the first embodiment of the present disclosure. This processing is given by way of example as the processing executed by the image forming apparatus 102 as the migration destination after the information processing apparatus 10 executes the processing illustrated in FIG. 10.

In step S1101, the communication unit 801 of the image forming apparatus 102 as the migration destination receives the setting information transmitted by the information processing apparatus 10 in step S1019 of the processing illustrated in FIG. 10.

In steps S1102 and S1103, the information reception unit 805 of the image forming apparatus 102 acquires the setting information received by the communication unit 801, and stores the acquired setting information in, for example, the storage unit 809. As described above, this setting information includes, in addition to the unencrypted setting information and the encrypted setting information, for example, the user ID and the conversion rule 411a for the encrypted setting information.

After the execution of the processing of steps S1101 to S1103, when the UI unit 802 of the image forming apparatus 102 receives the login input by the operator in steps S1111 and S1112, the image forming apparatus 102 executes the processing of step S1113 and subsequent steps. In the present embodiment, it is assumed that the operator whose login is received by the UI unit 802 is the same operator who has logged in the image forming apparatus 101 as the migration source in step S901 of the processing illustrated in FIG. 9.

In steps S1113 and S1114, the UI unit 802 acquires the setting information corresponding to the user ID from the storage unit 809 using the user ID of the logged-in operator. When a plurality of pieces of setting information corresponding to the user ID is stored in the storage unit 809, the UI unit 802 may display a list of pieces of the setting information corresponding to the user ID and allow the operator to select a piece of the setting information to be acquired.

In step S1115, the UI unit 802 displays a setting screen for receiving the setting of the encryption key for decrypting the encrypted setting information.

In steps S1116 and S1117, in response to receiving the setting of the encryption key operated by the operator, the UI unit 802 transmits a setting request that includes the setting information acquired from the storage unit 809 and the encryption key received by the UI unit 802 to the setting unit 808. In the present embodiment, as described above, the setting information acquired from the storage unit 809 includes, for example, the unencrypted setting information, the encrypted setting information, the user ID, and the conversion rule 411a for the encrypted setting information.

In step S1118, the setting unit 808 causes the decryption unit 806 to decrypt the encrypted setting information with the encryption key. For example, the decryption unit 806 decrypts the encrypted setting information 501 as illustrated in FIG. 5A with the encryption key to obtain the decrypted setting information 502 as illustrated in FIG. 5B.

In step S1119, the setting unit 808 causes the conversion unit 807 to convert the decrypted setting information using the conversion rule 411a. For example, the conversion unit 807 converts the decrypted setting information 502 as illustrated in FIG. 5B into the setting information suitable to the image forming apparatus 102 as the migration destination using the conversion rule 411a for the encrypted setting information as illustrated in FIG. 7A.

In step S1120, the setting unit 808 sets the unencrypted setting information included in the setting information received in step S1117 and the setting information converted in step S1119 in the image forming apparatus 102.

Through the processing of FIGS. 9 to 11, the information processing system 1 migrates the setting information of the image forming apparatus 101 as the migration source to the image forming apparatus 102 as the migration destination.

### Second Embodiment

In the second embodiment, the processing in a case where the conversion rules 411 managed by the information processing apparatus 10 include conversion rules corresponding to a plurality of image forming apparatuses 101 as migration sources and conversion rules corresponding to a plurality of image forming apparatuses 102 as migration destinations is described.

### Processing Flow

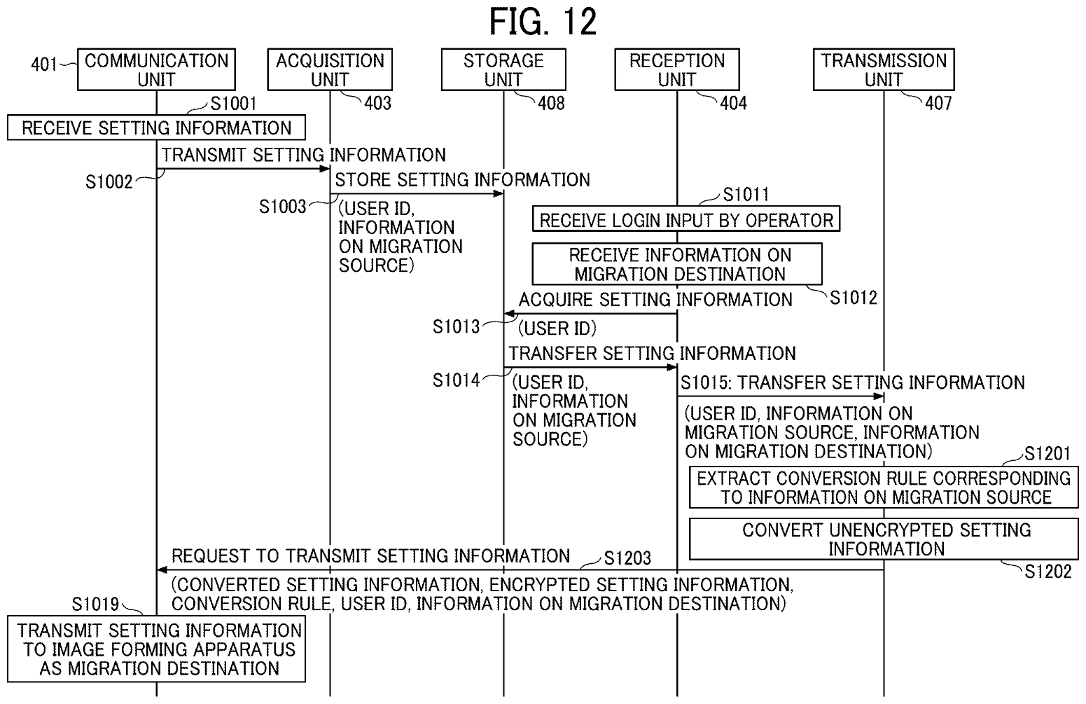

FIG. 12 is a sequence chart illustrating the processing executed by the information processing apparatus 10 according to the second embodiment of the present disclosure. Among steps of the processing illustrated in FIG. 12, the processing of steps S1001 to S1003, S1011 to S1015, and S1019 are substantially the same as those of the processing executed by the information processing apparatus 10 according to the first embodiment described with reference to FIG. 10, and redundant descriptions thereof are omitted below to simplify the description.

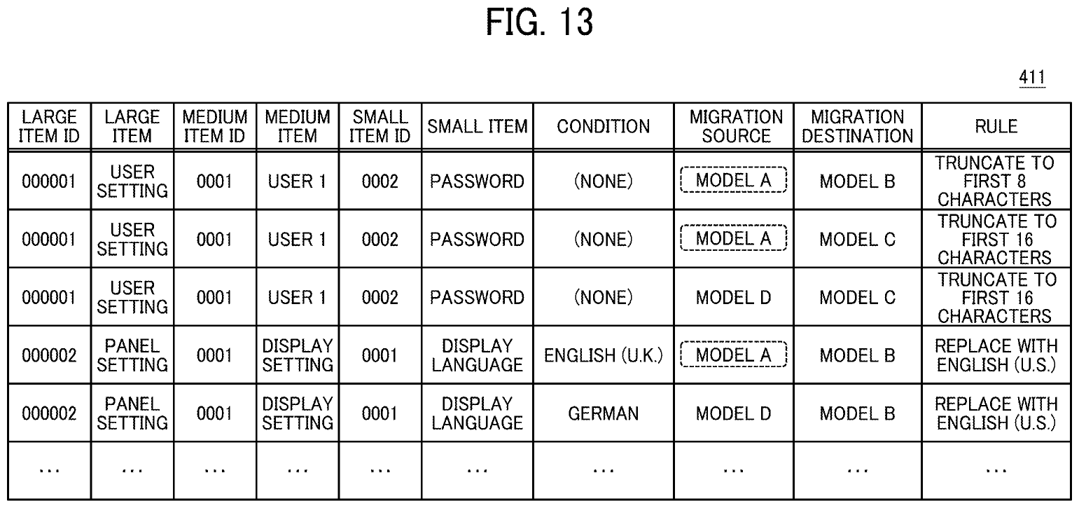

In step S1201, in response to receiving the setting information from the reception unit 404, the transmission unit 407 of the information processing apparatus 10 causes the extraction unit 406 to extract a conversion rule corresponding to the image forming apparatus 101 as the migration source from, for example, the conversion rules 411 as illustrated in FIG. 13.

FIG. 13 is a diagram illustrating a table of the conversion rules 411 according to the second embodiment of the present disclosure. As illustrated in FIG. 13, the conversion rules 411 according to the second embodiment include conversion rules for a plurality of migration sources (model A and model D) and a plurality of migration destinations (model B and model C).

For example, when the image forming apparatus 101 as the migration source is the “model A,” the extraction unit 406 extracts conversion rules that include the “model A” in the column of the migration source from the conversion rules 411 as illustrated in FIG. 13. When all the conversion rules including the “model A” as the migration source are transmitted to the image forming apparatus 102 as the migration destination regardless of the model of the migration destination, the processing may be simplified while the data size of the conversion rules in transmission increases.

In step S1202, the transmission unit 407 causes the conversion unit 405 to convert the unencrypted setting information included in the setting information transmitted by the reception unit 404 into setting information suitable to the image forming apparatus 102 as the migration destination.

In step S1203, the transmission unit 407 transmits, to the communication unit 401, a transmission request for transmitting the setting information. In the present embodiment, for example, the unencrypted setting information converted in step S1202, the encrypted setting information, the conversion rule extracted in step S1201, the user ID, and the information on the migration destination are included in the setting information requested to be transmitted.

As described above, according to the second embodiment, even when the conversion rules 411 include the conversion rules corresponding to the multiple image forming apparatuses 101 as the migration sources and the conversion rules corresponding to the multiple image forming apparatuses 102 as the migration destinations, the processing can be simplified.

As described above, according to the information processing system 1 according to the embodiments of the present disclosure, even when the setting information acquired from an electronic apparatus as a migration source is encrypted, the encrypted setting information can be migrated to another electronic apparatus as a migration destination.

Each function of the embodiments of the present disclosure described above may be implemented by one processing circuit or a plurality of processing circuits. The “processing circuit or circuitry” herein includes a programmed processor to execute functions by software, such as a processor implemented by an electronic circuit, and devices, such as an application specific integrated circuit (ASIC), a digital signal processor (DSP), a field programmable gate array (FPGA), and circuit modules known in the art arranged to perform the recited functions.

The group of apparatuses or devices described in the embodiments of the present disclosure is one of multiple computing environments to implement the embodiments disclosed in the present disclosure. In some embodiments, the information processing apparatus 10 includes multiple computing devices such as a server cluster. The multiple computing devices communicate with one another through any type of communication link including, for example, a network or a shared memory, and perform the operations disclosed herein.

Further, the components of the information processing apparatus 10 may be integrated into one apparatus or may be divided into multiple apparatuses. Furthermore, at least a part of the functional configurations of the information processing apparatus 10 and the image forming apparatuses 101 and 102 may be executed by using, for example, an external cloud service.

In this specification, an information processing apparatus, an information processing system, an information processing method, and a non-transitory recording medium according to the following respective aspects are disclosed.

### Aspect 1

An information processing apparatus that supports migration of setting information from a first electronic apparatus to a second electronic apparatus includes a management unit that manages a conversion rule of setting information corresponding to the first electronic apparatus, an acquisition unit that acquires encrypted setting information and information on the first electronic apparatus from the first electronic apparatus, a reception unit that receives information on the second electronic apparatus, and a transmission unit that transmits the encrypted setting information and the conversion rule corresponding to the first electronic apparatus to the second electronic apparatus.

### Aspect 2

According to Aspect 1, the first electronic apparatus is a first image forming apparatus, and the second electronic apparatus is a second image forming apparatus of a model different from a model of the first image forming apparatus.

### Aspect 3

According to Aspect 2, the information on the first electronic apparatus includes information that specifies the model of the first image forming apparatus, and the information on the second electronic apparatus includes information that specifies the model of the second image forming apparatus.

### Aspect 4

In the information processing apparatus according to Aspect 2 or 3, the conversion rule includes conversion information for converting the setting information on a first model that is the model of the first image forming apparatus into setting information of a second model that is the model of the second image forming apparatus.

### Aspect 5

An information processing system that includes the information processing apparatus according to any one of Aspects 1 to 4 and a first electronic apparatus that is communicable with the information processing apparatus via a communication network. The first electronic apparatus includes a UI unit that receives an input of an encryption key for encrypting setting information of the first electronic apparatus and an information transmission unit that transmits the setting information of the first electronic apparatus encrypted with the encryption key received by the UI unit and information on the first electronic apparatus to the information processing apparatus.

### Aspect 6

An information processing system that includes the information processing apparatus according to any one of Aspects 1 to 5 and a second electronic apparatus that is communicable with the information processing apparatus via a communication network. The second electronic apparatus includes an information reception unit that receives the encrypted setting information and the conversion rule from the information processing apparatus, a UI unit that receives an input of an encryption key for the encrypted setting information, and a setting unit that decrypts the encrypted setting information with the encryption key to obtain first setting information and sets second setting information converted from the first setting information with the conversion rule in the second electronic apparatus.

### Aspect 7

An information processing method performed by an information processing apparatus that supports migration of setting information from a first electronic apparatus to a second electronic apparatus includes managing a conversion rule of setting information corresponding to the first electronic apparatus, acquiring encrypted setting information and information on the first electronic apparatus from the first electronic apparatus, receiving information on the second electronic apparatus, and transmitting the encrypted setting information and the conversion rule corresponding to the first electronic apparatus to the second electronic apparatus.

### Aspect 8

A non-transitory recording medium storing a plurality of program codes which, when executed by one or more processors, causes the one or more processors to perform a method that includes managing a conversion rule of setting information corresponding to a first electronic apparatus, acquiring encrypted setting information and information on the first electronic apparatus from the first electronic apparatus, receiving information on a second electronic apparatus, and transmitting the encrypted setting information and the conversion rule corresponding to the first electronic apparatus to the second electronic apparatus.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

Processors are considered processing circuitry or circuitry as they include transistors and other circuitry therein. In the disclosure, the circuitry, units, or means are hardware that carries out or is programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing apparatus for supporting migration of setting information from a first electronic apparatus to a second electronic apparatus, comprising circuitry configured to:
store, in a memory, a conversion rule of setting information corresponding to the first electronic apparatus;
acquire encrypted setting information and information on the first electronic apparatus from the first electronic apparatus;
receive information on the second electronic apparatus; and
transmit the encrypted setting information and the conversion rule corresponding to the first electronic apparatus to the second electronic apparatus.

2. The information processing apparatus according to claim 1, wherein:
the first electronic apparatus is a first image forming apparatus; and
the second electronic apparatus is a second image forming apparatus of a model different from a model of the first image forming apparatus.

3. The information processing apparatus according to claim 2, wherein:
the information on the first electronic apparatus includes information that specifies the model of the first image forming apparatus; and
the information on the second electronic apparatus includes information that specifies the model of the second image forming apparatus.

4. The information processing apparatus according to claim 3, wherein the conversion rule includes conversion information for converting the setting information on a first model that is the model of the first image forming apparatus into setting information of a second model that is the model of the second image forming apparatus.

5. An information processing system comprising:
the information processing apparatus according to claim 1; and
a first electronic apparatus to communicate with the information processing apparatus via a communication network, including first circuitry configured to:
receive an input of an encryption key for encrypting setting information of the first electronic apparatus; and
transmit the setting information of the first electronic apparatus encrypted with the encryption key and information on the first electronic apparatus to the information processing apparatus.

6. An information processing system comprising:
the information processing apparatus according to claim 1; and
a second electronic apparatus to communicate with the information processing apparatus via a communication network, including second circuitry configured to:
receive the encrypted setting information and the conversion rule from the information processing apparatus;
receive an input of an encryption key for the encrypted setting information;
decrypt the encrypted setting information with the encryption key to obtain first setting information; and
set second setting information converted from the first setting information with the conversion rule in the second electronic apparatus.

7. An information processing method performed by an information processing apparatus for supporting migration of setting information from a first electronic apparatus to a second electronic apparatus, the method comprising:
storing, in a memory, a conversion rule of setting information corresponding to a first electronic apparatus;
acquiring encrypted setting information and information on the first electronic apparatus from the first electronic apparatus;
receiving information on a second electronic apparatus; and
transmitting the encrypted setting information and the conversion rule corresponding to the first electronic apparatus to the second electronic apparatus.

8. A non-transitory recording medium storing a plurality of program codes which, when executed by one or more processors, causes the one or more processors to perform a method, the method comprising:
storing, in a memory, a conversion rule of setting information corresponding to a first electronic apparatus;
acquiring encrypted setting information and information on the first electronic apparatus from the first electronic apparatus;
receiving information on a second electronic apparatus; and
transmitting the encrypted setting information and the conversion rule corresponding to the first electronic apparatus to the second electronic apparatus.
